(19) United States
(12) Patent Application Publication
(10) Pub. No.: US 2025/0231065 A1
(43) Pub. Date: Jul. 17, 2025

(54) FLEX-SPECTRUM OPTICAL DETECTOR

(71) Applicant: Lumentum Operations LLC, San Jose, CA (US)

(72) Inventors: Patrick LANGLOIS, Gatineau (CA); Barrie P. KEYWORTH, Ottawa (CA); Paul Dwight COLBOURNE, Ottawa (CA)

(21) Appl. No.: 18/790,944

(22) Filed: Jul. 31, 2024

Related U.S. Application Data
(60) Provisional application No. 63/620,080, filed on Jan. 11, 2024.

(51) Int. Cl. G01J 3/28; G01J 3/02; G01J 3/44

(52) U.S. Cl. CPC G01J 3/2889; G01J 3/4406; G01J 3/4412; G01J 3/0229

(57) ABSTRACT

An optical system may include an optical source to provide an excitation light and a collecting element to direct an optical signal, received from a sample in response to incidence of the excitation light on the sample, to an optical device. The optical device may include a separating element to separate the optical signal into a plurality of spectral bands that are spatially or angularly separated along a band separation direction, a dispersive element comprising a dispersive region to disperse spectral components of a spectral band along a dispersion direction to form a dispersed spectral band, and an optical element to manipulate the dispersed spectral band in association with imaging the spectral band onto a detector area of a detector array. The optical system may include a controller to obtain one or more read-out signals from the detector array.

### CROSS-REFERENCE TO RELATED APPLICATION

This patent application claims priority to U.S. Provisional Patent Application No. 63/620,080, filed on Jan. 11, 2024, and entitled “FLEX SPECTRUM SPECTROMETRY.” The disclosure of the prior Application is considered part of and is incorporated by reference into this patent application.

### TECHNICAL FIELD

The present disclosure relates generally to an optical detector and to a flex-spectrum optical detector.

### BACKGROUND

In spectrometry, a full spectrum response is conventionally dispersed such that the dispersed spectrum has the shape of a continuous elongated beam (with a large width-to-height aspect ratio) comprised of dispersed spectral bands. Conventionally, the dispersed spectral bands are arranged in a “linear” one-dimensional (1D) sequence from one edge of a beam to another edge of the beam, either without any discontinuity, or with only one spectral band imaged in a direction perpendicular to the direction of dispersion, for any detector pixel location along the direction of dispersion. When performing spectroscopy, it is commonly desired to detect a response from a sample with high sensitivity and high resolution across the full spectrum (e.g., for Raman spectrometers, a spectral range above 100 nanometers (nm) (in wavelength) or above 3000 reciprocal centimeters (cm⁻¹) (in wavenumbers)).

### SUMMARY

In some implementations, an optical system includes an optical source to provide an excitation light; a collecting element to: direct an optical signal, received from a sample in response to incidence of the excitation light on the sample, to an optical device; the optical device comprising: a separating element to separate the optical signal into a plurality of spectral bands that are spatially or angularly separated along a band separation direction, wherein spectral ranges differ among each spectral band of the plurality of spectral bands, a dispersive element comprising a plurality of dispersive regions, wherein a dispersive region of the plurality of dispersive regions is to disperse spectral components of a spectral band, of the plurality of spectral bands, along a dispersion direction to form a dispersed spectral band, a plurality of optical elements, wherein an optical element of the plurality of optical elements is to manipulate the dispersed spectral band in association with imaging the spectral band onto a detector area of a detector array, and the detector array comprising the detector area; and a controller to obtain one or more read-out signals from the detector array.

In some implementations, an optical system includes an optical source to provide an excitation light; a collecting element to direct an optical signal, received in response to incidence of the excitation light on a sample, to an optical device; the optical device to: separate the optical signal into a plurality of spectral bands that are spatially or angularly separated along a band separation direction, each spectral band of the plurality of spectral bands having a different spectral range, disperse spectral components of a spectral band, of the plurality of spectral bands, along a dispersion direction to form a dispersed spectral band, manipulate the dispersed spectral band in association with imaging the spectral band onto a detector area of a detector array of the optical device; and a controller to obtain one or more read-out signals from the detector array.

In some implementations, an optical system includes an optical source to provide an excitation light; a collecting element to direct an optical signal, received in response to incidence of the excitation light on a sample, to an optical device; the optical device comprising: a separating element to separate the optical signal into a plurality of spectral bands; wherein spectral ranges differ among each spectral band of the plurality of spectral bands; a dispersive element comprising a dispersive region, wherein the dispersive region is to disperse spectral components of a spectral band, of the plurality of spectral bands to form a dispersed spectral band; an optical element is to manipulate the dispersed spectral band in association with imaging the spectral band onto a detector area of a detector array, and the detector array comprising the detector area; and a controller to coordinate operation of the optical source with operation of the collecting element or one or more elements of the optical device such that timing of receipt of the optical signal is synchronized with timing of an acquisition window of the detector area.

### BRIEF DESCRIPTION OF THE DRAWINGS

FIGS. 1A-1C are diagrams illustrating examples associated with an optical system comprising a flex-spectrum optical detector described herein.

FIG. 2 illustrates an example associated with an optical device that provides flexible segmentation and arrangement of a full spectrum.

FIGS. 3 and 4 are diagrams associated with increasing a dynamic range and sensitivity as enabled by an optical device described herein.

FIGS. 5-7 are diagrams illustrating example implementations of a separating element described herein.

### DETAILED DESCRIPTION

The following detailed description of example implementations refers to the accompanying drawings. The same reference numbers in different drawings may identify the same or similar elements.

In spectrometry, a spectrograph is conventionally designed to provide light in the form of a single, non-segmented, linear optical beam containing a full spectral range interrogated by the spectrograph at a dispersive element of the spectrograph. The dispersive element disperses the light, and the dispersed light is projected as a continuous, non-segmented, linear image on a detector of the spectrograph. Here, the dispersed spectrum traditionally has the shape of a continuous elongated beam (with a large width-to-height aspect ratio) comprised of dispersed spectral components that are arranged in a “linear” 1D sequence from one edge of a beam to another edge of the beam, either without any discontinuity, or with only one spectral component imaged in a direction perpendicular to a direction of dispersion, for any detector pixel location along the dispersion direction. When performing spectroscopy, it is commonly desired to detect a response from a sample with high sensitivity and high resolution across the full spectrum (e.g., for Raman spectrometers, a spectral range above 100 nanometers (nm) (in wavelength) or above 3000 reciprocal centimeters (cm⁻¹) (in wavenumbers)). However, this is difficult to efficiently implement in practice. For example, if a high sensitivity and high-resolution detector array is required across a full spectrum, the physical design of the detector would have to accommodate a large width-to-height aspect ratio, which leads to inefficient use of physical space in a spectrometer system. Accordingly, it would be advantageous to discard the conventional 1D shape of the dispersed spectrum and avoid the large aspect ratio of the detector and be compatible with more typical 2D imaging detector arrays.

Additionally, any dispersed spectrum has two important attributes: spectral range and spectral resolution. These attributes conflict with one another for a fixed spectrum physical width. That is, for a given spectral range, there is a given spectral resolution. Increasing the resolution leads to an increased spectral width for a fixed spectral range, or a reduced spectral range for a fixed spectral width. These constraints are present for a 1D spectrum imaged on a detector. When performing spectroscopy, it is common for all spectral bands within the full spectrum response to have nominally the same degree of sensitivity and resolution. However, most conventional spectroscopy systems aim to identify specific characteristics for which one or more particular spectral bands can provide more useful identifying information, while other spectral bands may provide minimal identifying information. This can make poor use of the detector if all spectral bands have the same sensitivity and resolution. Accordingly, it would be advantageous to provide greater sensitivity and resolution for spectral bands that provide more useful identifying information, and lower sensitivity and resolution for spectral bands that provide less useful identifying information. Similarly, some spectral bands of the full spectrum may provide no useful information at all and, therefore, avoiding imaging those spectral bands on the detector would be advantageous.

A conventional two-dimensional (2D) technique can in some cases be used to divide (e.g., through a beam-splitter) a full spectrum into several beams, each containing the full spectral range. Then, different spectral range portions of each beam are imaged onto different detectors. Notably, according to this conventional 2D technique, each beam includes the full spectrum at a fraction of the original power, and then only a fraction of different spectral bands from each beam are imaged onto a detector. This wastes power because the original power is split into each full-spectrum beam and then the portions of each beam that are not imaged onto the detector are wasted. Thus, even those spectral ranges that are imaged onto a portion of the detector include only a fraction of the original power in that spectral range. Wasted power also reduces sensitivity. Accordingly, it would be advantageous to image as much power from the full spectrum response onto the detector as possible.

Implementations described herein provide techniques and apparatuses for measurement of spectral responses in which a full spectrum response can be divided into spectral bands (e.g., sub-spectra of any spectral range, resolution, or dynamic range), and each spectral band can be directed through dispersion and to a desired physical location on a detector array, while preserving power of the full spectrum response. In other words, the techniques and apparatuses described herein can be implemented to separate a full spectral response into a group of distinct spectral bands (e.g., sub-spectra) in wavelength or wavenumber with minimal power loss, and these spectral bands can then be independently manipulated or rearranged before spectral dispersion and imaging onto a detector (e.g., a 2D detector). The techniques and apparatuses described herein avoid power loss when splitting the full spectrum response; decouple bandwidth, resolution, and dynamic range constraints for each spectral band; increase efficiency with respect to use of a 2D detector; and enable a more compact spectrograph.

The techniques and apparatuses described herein enable a comparatively more compact spectrograph by separating a full spectrum of incident light into spectral bands with no loss of power (other than power loss caused by non-idealities of optical components performing the separating function), and spatially re-arranging the spectral bands (e.g., into a stack) before passing the spectral bands to a dispersive element. Such a design may enable higher optical resolution per spectral band from the dispersive element and may in some designs enable a reduced size of the dispersive element in a dispersion direction. After dispersion, the dispersed spectral bands are projected and imaged (e.g., in a stack) onto a 2D detector array, thereby enabling higher detector resolution and increasing efficiency with respect to usage of an active area of the detector array.

The techniques and apparatuses described herein incorporate spectral banding at a front-end, which splits a full spectral range into multiple spectral bands (e.g., a set of adjacent, sequential or different spectral ranges) before dispersion. In some implementations, the spectral bands may be non-overlapping, or may be partially (e.g., minimally) overlapping or nearly non-overlapping (e.g., to allow for redundancy or tolerance to manufacturing when attempting to create non-overlapping or adjacent spectral bands). In some implementations, the spectral bands can be rearranged in space and stacked onto a dispersive element in a non-dispersive direction (e.g., a direction perpendicular to the dispersion direction), thereby creating a 2D arrangement of spectral bands. In some implementations, the dispersive element may comprise multiple dispersive regions (e.g., each with different dispersive properties) which can map to the spectral bands incident thereon. Each dispersive region of the dispersive element can thus disperse and redirect light incident thereon independently of the other dispersive regions.

After dispersion, the spatial arrangement of the dispersed spectral bands can be maintained or further rearranged as the dispersed spectral bands are directed to a detector array. For example, in some implementations, the dispersed spectral bands can be arranged in space and stacked onto a 2D detector array in a band separating direction. The spectral bands can be rearranged in a variety of ways (e.g., depending on the selected spectral range divisions and resolution targets). In general, the number of spectral bands, the spectral ranges of the spectral bands, and the spectral resolutions of the spectral bands can be varied and set freely and independently of each other in accordance with a desired performance target for a given application (e.g., Raman, time-gated Raman, spatially offset Raman spectroscopy (SORS), fluorescence, or the like). For example, a spectrum formed by the sum of all spectral bands may be non-continuous (e.g., interrupted by one or more gaps) or may have different spectral resolutions for different sub-spectra. Additionally, or alternatively, a dynamic range and the sensitivity desired for measurement of each spectral band can be set freely and independently of the other spectral bands by controlling a “height” (e.g., in a direction orthogonal to the dispersion direction) that each spectral band is imaged onto the detector. While increasing the detector area illuminated by a particular spectral band does not change the total amount of photons in that spectral band, increasing the detector area increases the dynamic range that can be achieved for that spectral band and increases a saturation limit of the detector for wavelengths in that spectral band because the photons are spread to more pixels of the detector. In some implementations, the techniques and apparatuses described herein enable one or more spectral bands (e.g., one or more spectral bands that are not of interest) to be removed. For example, one or more spectral bands can be removed from imaging on the detector during splitting of the spectrum, during dispersion, or during spatial or angular re-arrangement (e.g., before or after dispersion).

Notably, the techniques and apparatuses described herein enable segmentation of the full spectrum in a different manner than the conventional 2D technique described above. In some implementations, the full spectrum is separated into spectral bands that are different in wavelength/wavenumber range and which are then rearranged spatially to have a 2D arrangement in which multiple spectral bands (which together, can cover the full spectral range and include nearly all the power of the original spectrum) are stacked in a direction perpendicular to the dispersion direction. In such an arrangement, higher resolution can be achieved, as compared to a 1D arrangement (i.e., on a 1D detector) of the same width. For comparison, achieving the same full spectral range with increased resolution with a linear, 1D, response would require a detector having a spectral dispersion dimension increased by a factor equivalent to the number of spectral bands created (e.g., assuming that all of the spectral bands have the same width and cover the same spectral range). As compared to the conventional 2D technique, there is minimal power loss because the full spectrum has been divided into separate, (optionally) non-overlapping, spectral bands including nearly all of the power of the full spectrum. This flex-spectrum spectrometry technique allows maximal use of an active area of a detector, which may be a rectangularly shaped (e.g., a low width-to-height ratio) 2D detector array. In some implementations, the full spectrum can be separated into separate non-overlapping spectral bands that are rearranged spatially to stack in alignment onto a low width-to-height ratio active area of a 2D detector array.

For the same physical size as a conventional 1D solution, the techniques and apparatuses described herein can achieve a higher resolution and/or cover a larger spectral range. Alternatively, the techniques and apparatuses described herein can achieve the same performance in a reduced width of the detector in the dispersion direction, which is typically the largest dimension of the detector used in spectrometry, at a fraction of the physical size of the conventional 1D technique. Segmenting the spectrum to reduce the width, while adding to the height from the rearrangement of the segmented spectral bands in a direction perpendicular to the dispersion direction (i.e., the band separation direction) leads to a favorable detector geometry with respect to enabling a compact size (e.g., volume) spectrometer or spectrometry system, or with respect to compatibility with a wider selection of commercially available large pixel count detector arrays (e.g., SPAD arrays). The addition of height on the detector to cover the additional spectral bands leads to marginal or no increase in height of the spectrometer, while the reduction in width of the detector leads to significant footprint reduction due to a smaller angular spread of the dispersed sub-spectra and their smaller width on a plane of the detector. As a consequence of the reduced width of the detector, the sizes of optical and mechanical components within the spectrometer are also reduced, which leads to a reduced size, weight, and (potentially) power consumption of the spectrometer system.

As described above, for a given detector width along the dispersion direction, the techniques and apparatuses described herein can achieve higher resolution and/or cover a larger spectral range. Performance attributes of a spectrometer are no longer fixed or constrained by the detector width. Adding a second dimension to the spectral arrangement allows for this flexibility. The techniques and apparatuses described herein enable varying the detection dynamic range and sensitivity across the full spectral range. Because the spectrum is segmented, each spectral band can be adjusted to cover any specific height (i.e., a number of pixels in the band separation direction) on an active area of the detector. Hence, detection dynamic range and sensitivity (which scales with the height of a spectral component on the detector active area) can be modulated across the various spectral bands to reflect, for example, target relative importance of the various spectral bands in a spectrometry measurement.

In practice, a spectrograph can be used in, for example, a Raman spectroscopy application that uses a time-gating principle. The time-gating principle in Raman spectroscopy is used to suppress sample-induced fluorescence, as well as phosphorescence, during the measurement process, as well as to maintain a signal-to-noise ratio (SNR) that is sufficiently high, while suppressing other potential continuous disturbances (e.g., ambient light, thermal emissions, or the like). Time-gated Raman spectroscopy is an effective technical solution for the issue of sample-induced fluorescence, which could mask a Raman signal during spectral detection. Conventional optical systems for performing time-gated Raman spectroscopy use a conventional spectrograph that implements the 1D technique described above, and therefore suffer from a performance versus size trade-off as a result of the manner in which light is manipulated (e.g., dispersion into a single, non-segmented, linear optical beam containing the full spectral range; and projection as a continuous, non-segmented, linear image on a detector). As noted above, this technique requires a wide dispersive element (in the dispersion direction) for the same dispersive power to achieve a given spectral resolution and, furthermore, requires a wide detector area to cover the full spectral range, for a given spectral range and resolution. As an alternative to the wide detector area, to cover the full spectral range for a given spectral range and resolution, an angle of incidence at the dispersive element may be stepped or scanned and the spectrum may be sequentially stitched together using a comparatively smaller 1D detector array.

In some implementations, the compact spectrograph described herein can be included in an optical system to be used in a time-gated Raman spectroscopy application or another type of spectroscopy application, such as a time-resolved fluorescence spectroscopy application, a dynamic, real-time spatial offset Raman spectroscopy (SORS) application, a laser induced breakdown spectroscopy (LIBS) application, or a photo-acoustic spectroscopy application, among other examples. In general, for a given application, the number of spectral bands provided by the spectrograph can be varied, and a spectral range and/or a spectral resolution of a given spectral band can be set freely and independently of other spectral bands. In this way, the optical system may be capable of satisfying a performance target for the optical system in a given application. Additional details are provided below.

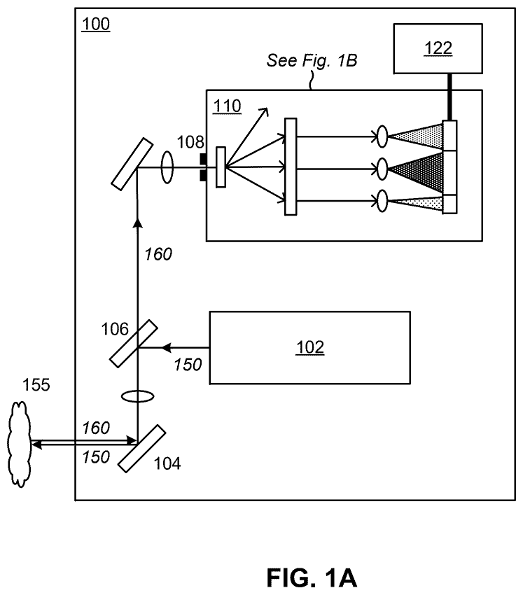

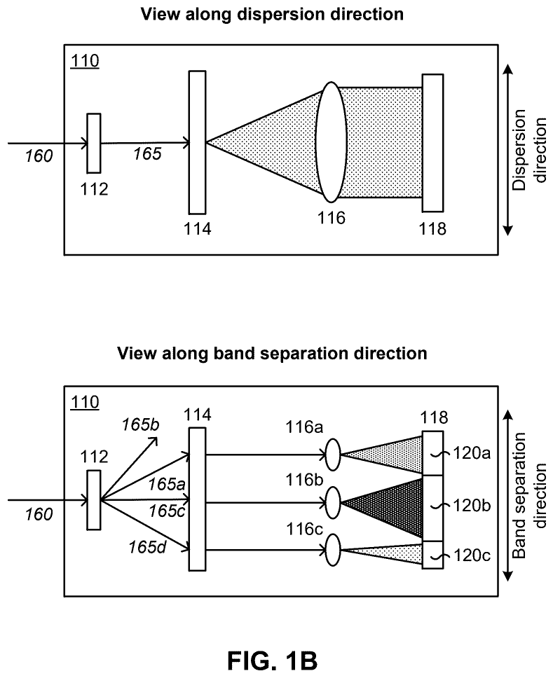

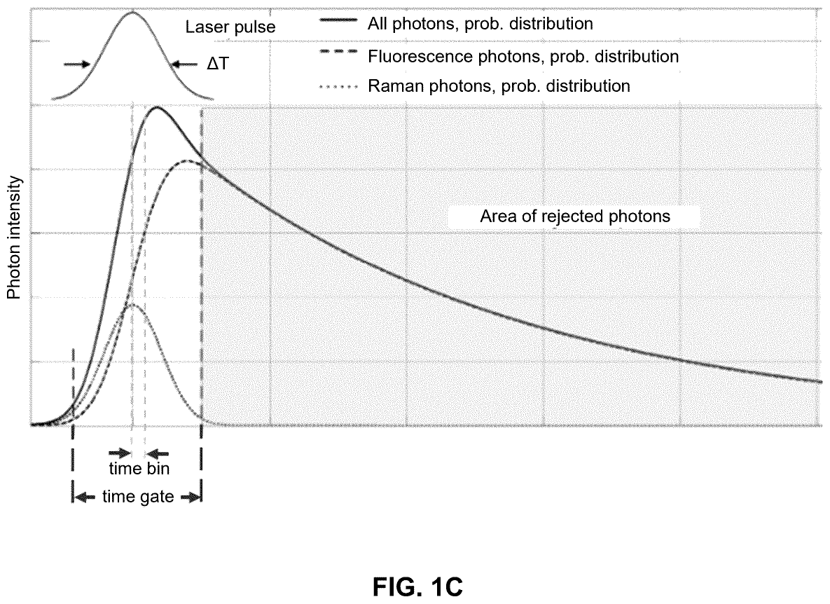

FIGS. 1A-1C are diagrams illustrating examples associated with an optical system 100 comprising a flex-spectrum optical detector 110 described herein. As shown in FIG. 1A, the optical system 100 may include an optical source 102, a collecting element 104, a filter 106, a slit 108, the flex-spectrum optical detector 110 (herein referred to as optical device 110), and a controller 122. As shown, the optical system 100 may include one or more other elements associated with manipulating or directing light, such as one or more directing elements (e.g., one or more mirrors) or one or more lenses (not labeled in FIG. 1A), depending on a design of the optical system 100. In one example, the optical system 100 comprises a compact Raman spectroscopy engine that can be used in a desktop, handheld, or embedded application. In some implementations, one or more elements of the optical system 100 may be included in a hermetic package. In one example implementation, elements of the optical system 100 other than the optical source 102 may be housed in a hermetic package. The hermetic package may be, for example, a sealed metallic enclosure. In some implementations, hermetic sealing may improve reliability of one or more elements of the optical system 100, such as a collecting element 104 in the form of a MEMS device or a thermoelectric cooler (TEC) used for laser cooling (not shown in FIG. 1A), among other examples. Further, in some implementations, hermetic sealing may improve wavelength stability of grating dispersion (i.e., calibration).

The optical source 102 includes one or more elements to provide excitation light 150. In some implementations, the optical source 102 may be a pulsed laser source. In some implementations, the optical source 102 may provide the excitation light 150 such that the excitation light 150 comprises optical pulses with a high repetition rate (e.g., greater than approximately 500 kilohertz (kHz)), a low energy (e.g., less than approximately 100 nanojoules (nJ)), and a narrow linewidth (e.g., less than approximately 0.1 nanometers (nm)) for a given wavelength. In some implementations, the wavelength of the excitation light 150 may be approximately equal to 532 nm. However, in practice the optical source 102 may be designed so as to provide excitation light 150 of any practical wavelength. In some implementations, the optical source 102 may be capable of reducing timing jitter in the excitation light 150 or may be capable of performing synchronization to account for jitter in the excitation light 150. That is, in some implementations, the optical source 102 may be a low-jitter laser source. The optical source 102 may be controlled by the controller 122 to achieve the above functions.

In some implementations, the optical source 102 may be a plurality of optical sources 102, where each source of the plurality of optical sources 102 is configured to, for example, emit at a different wavelength, generate excitation light 150 with different pulse characteristics (e.g., pulse width, repetition rate, pulse energy, or the like) or operate in a different operation mode (e.g., continuous wave (CW), Q-switched, mode-locked, or the like). In some implementations, as shown in FIG. 1A, the excitation light 150 is provided such that the excitation light 150 is incident on a sample 155. In some implementations, the use of a plurality of optical sources 102 may serve to better utilize a spectral range detected by the optical system 100. For example, in Raman spectroscopy, there is a “silent region” in the Raman shift spectrum, typically in a range from approximately 1800 cm⁻¹ to approximately 2800 cm⁻¹. In some such applications, a (second) optical source 102 may provide another excitation wavelength to fill that spectral band with Raman shifts from a spectral region of interest. Different excitation wavelengths have different interactions with sample material, impacting in different ways important parameters of the measurement, such as the Raman scattering efficiency, the amount of fluorescence background generated, the damage threshold, and the like. Thus, a combination of multiple optical sources 102 that each provide respective (narrowband) excitation light 150 may be used to improve the optical system 100 for a given application. In some implementations, an optical source 102 of the optical system 100 may be included in a hermetic package that houses one or more other elements of the optical system 100. An optical source 102 internal to the hermetic package may be advantageous, for example, to achieve an implementation in which integration of the optical system 100 (e.g., in a single package) is desirable. Additionally, or alternatively, an optical source 102 of the optical system 100 may be external to a hermetic package that houses one or more other elements of the optical system 100. In such an implementation, the optical source 102 may be housed in a second hermetic package (i.e., a hermetic package separate from that which houses the one or more other elements of the optical system 100). An optical source 102 external to the hermetic package may be advantageous, for example, to ease thermal management (e.g., because the optical source 102 may be a primary heat source of the optical system 100), to facilitate replacement or swapping of optical sources (e.g., with another optical source 102 of different laser type or having a different characteristic), or to increase flexibility in laser design.

The collecting element 104 includes one or more elements to direct an optical signal 160, received from the sample 155 in response to incidence of the excitation light 150 on the sample 155, to the optical device 110. For example, the collecting element 104 may include one or more reflective elements, such as one or more microelectromechanical systems (MEMS) mirrors. In some implementations, a collecting element 104 in the form of a MEMS mirror may be used to scan pulses of the excitation light 150 over a 1D or 2D region of the sample 155, or to dither the excitation light 150 to avoid damage to or heating of the sample 155. In some implementations, the collecting element 104 may be omitted from the optical system 100 (i.e., some implementations of the optical system 100 may not include the collecting element 104). In an example of one such implementation, the excitation light 150 may be transmitted through the filter 106 to be incident on the sample 155, and the optical signal 160 from the sample 155 may be reflected by the filter 106 on the optical path toward the optical device 110.

The filter 106 includes one or more elements to remove one or more excitation wavelengths from the optical signal 160. For example, as indicated in FIG. 1A, the filter 106 may comprise an element that reflects light at the excitation wavelength (e.g., 532 nm) and transmits light at other wavelengths.

The slit 108 includes one or more elements associated with defining (in combination with the optical device 110) an optical throughput and an optical resolution of the optical system 100. In some implementations, the slit 108 is a mechanical feature, such as an opening (e.g., a rectangular opening) in a blocking screen. In some implementations, the optical signal 160 is focused by one or more other elements of the optical system 100 so as to maximize transmission of the optical signal 160 through the slit 108.

Notably, the example optical paths illustrated in FIG. 1A are provided for illustrative purposes, and other implementations are possible. For example, on an optical path of the excitation light 150 shown in FIG. 1A, the excitation light 150 is reflected by the filter 106 and directed by the collecting element 104 to the sample 155. Further, on an optical path of the optical signal 160 as shown in FIG. 1A, the optical signal 160 is reflected by the collecting element 104, transmitted by the filter 106, and is directed by a reflective element to the optical device 110. In this example, the collecting element 104 and the filter 106 are on both the optical path of the optical signal 160 and the optical path of the excitation light 150. However, in another example implementation, the optical path of the optical signal 160 and the optical path of the excitation light 150 may be separate independent optical paths.

The optical device 110 comprises a flex-spectrum optical detector as described herein. FIG. 1B is a diagram illustrating an example implementation of the optical device 110. As shown in FIG. 1B, the optical device 110 comprises a separating element 112, a dispersive element 114, a plurality of optical elements 116 (e.g., comprising optical element 116a, optical element 116b, and optical element 116c), and a detector array 118 comprising a set of detector areas 120 (e.g., detector area 120a, detector area 110b, detector area 120c). The top diagram in FIG. 1B illustrates an example of a view of the optical device 110 along a dispersion direction (i.e., a direction along which the dispersive element 114 disperses spectral bands 165, as described below), while the bottom diagram in FIG. 1B illustrates an example of a view of the optical device 110 along a band separation direction (i.e., a direction along which the separating element 112 separates the optical signal 160 into a plurality of spectral bands 165, as described below). As shown in FIG. 1B, the optical signal 160 from the sample 155 (e.g., an altered transmitted signal from the optical source 102, a signal generated by the sample 155 as a consequence of excitation by the excitation light 150, or the like) includes spectral information (i.e., a spectral response) which is directed to the optical device 110.

The separating element 112 comprises one or more elements to separate the optical signal 160 into a plurality of spectral bands 165. That is, the separating element 112 comprises one or more elements that segment (e.g., by spectral range) and rearrange (e.g., spatially/angularly) the spectral response from the sample 155 into spatially and/or angularly re-arranged spectral bands (e.g., spectral band 165a, spectral band 165b, spectral band 165c, and spectral band 165d). In some implementations, the direction along which the separating element 112 spatially or angularly separates the optical signal 160 into the plurality of spectral bands 165 is referred to as the band separation direction. In some implementations, the band separation direction is perpendicular to a dispersion direction (e.g., a direction along which the dispersive element 114 disperses spectral bands 165). Notably, while the band separation direction being perpendicular to the dispersion direction may be used for practical purposes, a geometry in which the band separation direction is not perpendicular to the dispersion direction may be used in some implementations (e.g., depending on a detector geometry). In some implementations, the separation of the optical signal 160 (e.g., the segmentation and rearrangement of the spectrum) is performed in a single direction—the band separation direction. As one example, the separating element 112 may change an angle of wavelengths of the optical signal 160 so as to create a continuous spatial spectrum spread in the band separation direction.

The separating element 112 can be configured so as to provide any number of spectral bands with different properties (e.g., physical size and orientation in space, spectral range, and/or spectral width). In some implementations, spectral ranges differ among each spectral band 165 of the plurality of spectral bands 165. In some implementations, spectral bands 165 in the plurality of spectral bands 165 may be substantially non-overlapping (e.g., such that each spectral band 165 covers a substantially different frequency range). Such an implementation may be utilized to, for example, maximize a spectral range covered by the banding of the optical signal 160 provided by the separating element 112. In some such implementations, an overlap between a given pair of adjacent spectral bands 165 may be small (e.g., a maximum overlap in a range from approximately 2% to approximately 10%). Such an overlap may be utilized to, for example, avoid gaps between spectral bands 165 that could otherwise arise from design or manufacturing non-idealities. Additionally, or alternatively, spectral bands 165 in the plurality of spectral bands 165 may be substantially overlapping (e.g., an overlap in frequency range that is greater than approximately 10%) so as to provide significant spectral redundancy. As an example, an application may require the same sub-band spectral range (e.g., approximately 100% overlap) to be detected by two different detector areas 120 of the detector array 118 (e.g., when the two detector areas 120 have different detector properties, when power in each “identical” spectral band 165 is intentionally made different when incident on a respective dedicated detector area 120, or the like).

In some implementations, the separating element 12 may be configured such that optical power differs among spectral bands 165 (e.g., such that an optical power of a given spectral band 165 is controlled to a desired degree or intentionally differs from an optical power of another spectral band 165). Such an implementation may be used when, for example, different detector areas 120 have different input optical power saturation levels (or thresholds) and having the different detector areas 120 behave similarly is desirable. As another example, such an implementation may be used when the use of a detector area 120 with different input power levels is desirable to probe the detector area 120 in different input optical power saturation regimes (e.g., multiple spectral bands 165 with the same spectral range but with different optical power could be sent to multiple nominally identical detector areas 120).

In some implementations, the separating element 112 may segment the optical signal 160 into spectral bands with no loss of power (e.g., other than power loss caused by component non-idealities). Notably, conventional techniques are based on power splitting rather than spectral separation. In other words, the conventional techniques split an optical signal into N (N>1) roughly equivalent sub-beams, where each sub-beam has 1/N^{th} of the power from each spectral band of the full spectrum. Conversely, the separation provided by the separating element 112 separates the optical signal 160 into the plurality of spectral bands 165 with all of the power from its respective band and none of the power from the other bands (within reasonable component non-idealities). Accordingly, the separation provided by the separating element 112 preserves the power that is relevant for each spectral band, which enables increased throughput, thereby enabling increased sensitivity. Additionally, preservation of power that is relevant for each spectral band enables increased measurement speed for spectrometry. For example, a SNR for a given detected spectral component (e.g., a Raman peak within a portion of the spectrum) for a given detection time (i.e., a photon collection time) is roughly proportional to a square root of a number of detected Raman photons. For a given excitation pulse energy and number of excitation pulses (or equivalently, a detection time window), there are comparatively more Raman photons reaching the detector within that spectral component and, therefore, a higher SNR is achieved with spectral splitting (as compared to power splitting). This means that, for the same SNR, spectral splitting requires a smaller number of pulses, hence a reduced detection time window, which is equivalent to an increase in measurement speed.

The dispersive element 114 comprises one or more elements to disperse spectral components of spectral bands 165 to form dispersed spectral bands 165. That is, the dispersive element 114 comprises one or more elements that disperse the spectral bands 165 (e.g., the spectral bands 165a through 165d) to form a plurality of dispersed spectral bands 165 (e.g., dispersed spectral band 165a, dispersed spectral band 165c, and dispersed spectral band 165d in the example shown in FIG. 1B). In some implementations, the dispersive element 114 may include one or more elements capable of spatially separating incoming light into different spectral components (e.g., wavelengths). For example, the dispersive element 114 may include a diffraction grating, a prism, or any other wavelength dispersive element. In one example implementation, the spatially separated spectral bands 165 are incident upon a diffraction grating with spatially separated sections (which may or may not be contiguous), with each section being designed to operate with the corresponding incident spectral band 165. In some implementations, the direction along which the dispersive element 114 disperses a spectral band 165 is referred to as the dispersion direction. In some implementations, the dispersive element 114 comprises a plurality of dispersive regions (e.g., each to disperse a respective one of the plurality of spectral bands 165). In some implementations, the plurality of dispersive regions may be stacked along the band separation direction (e.g., perpendicular to the dispersion direction). In some implementations, a given dispersive region of the dispersive element 114 disperses a spectral band 165 incident thereon independently of dispersion by other dispersive regions of the dispersive element 114. For example, in some implementations, the plurality of dispersive regions may be monolithically patterned (or mechanically tiled) onto a single dispersive element 114, with each dispersive region having a respective (e.g., different) set of dispersive properties.

In operation, the dispersive element 114 serves to physically separate spectral components forming a given spectral band 165 such that the spectral components of the given spectral band 165 emerge from the dispersive element 114 with different angles and positions so as to form a dispersed spectral band 165. In some implementations, the dispersive regions of the dispersive element 114 may operate differently on each spectral band 165 so as to produce dispersed spectral bands 165 having different optical properties (e.g., physical size and orientation in space, spectral range, spectral width, spectral resolution, or the like). For example, a given dispersive region of the dispersive element 114 may segment or separate angularly and spatially a continuous spatial spectrum into individual bands. In some implementations, the dispersive element 114 may define a spectral range of a given spectral band 165.

The plurality of optical elements 116 comprises one or more elements to manipulate the dispersed spectral bands 165 in association with imaging the spectral bands 165 onto detector areas 120 of the detector array 118. In some implementations, the plurality of optical elements 116 comprises an imaging sub-system for spectral bands 165 to be imaged onto the detector array 118. In some implementations, the plurality of optical elements 116 includes a plurality of elements capable of manipulating a location, a size, and/or an orientation/direction of spectral bands 165 in order to image one or more spectral bands 165 from the plurality of spectral bands 165 onto the detector array 118 and with a particular arrangement (e.g., as dictated by the size of the detector array 118 and/or performance attributes and/or functional criteria). For example, a given optical element 116 may include one or more lenses, prisms, wedges, mirrors, diffraction gratings, bulk optics, or the like, and combinations thereof. In some implementations, a given optical element 116 can preserve one or more properties (e.g., a spectral range, a spectral resolution, a detection dynamic range and sensitivity, a physical size or location on a plane of the detector array 118, or the like) of a given spectral band 165 and image such properties onto a particular detector area 120 of the detector array 118. Additionally, or alternatively, a given optical element 116 can modify one or more properties of a given spectral band 165. For example, an optical element 116 can be designed so that a width of the detector array 118 is filled so as to provide a highest resolution and/or so as to determine a height of the detector array 118 that is used for each respective spectral band 165 (e.g., to control dynamic range and sensitivity). In some implementations, the plurality of optical elements 116 may serve to arrange the dispersed spectral bands 165 so as to optimize usage of the detector array 118 (e.g., to maximize an area utilized on the detector array 118, to maximize optical resolution, to utilize a specific detector area 120 on the detector array 118 for a specific spectral band 165, or the like). For example, the plurality of optical elements 116 can expand the dispersed spectral bands 165 to match a width of the detector array 118 and stack each spectral band 165 in detector areas 120 with respective heights on the detector array 118. In some implementations, the plurality of optical elements 116 may manipulate (e.g., direct, steer, focus, collimate, converge, expand, or the like) the dispersed spectral band 165 such that images of the spectral bands 165 are stacked along the band separation direction at a plane of the detector area 120. For example, the plurality of optical elements 116 may in some implementations provide spatial rearrangement of the plurality of spectral bands 165 on a plane of the detector area 120. In some implementations, an optical element 116 in the plurality of optical elements 116 may manipulate (e.g., expand) a dispersed spectral band 165 such that a size of the dispersed spectral band 165 along the dispersion direction matches a size of a detector area 120 along the dispersion direction (e.g., an area of the detector array 118 on which the spectral band 165 is to be imaged). Similarly, in some implementations, the optical element 116 may manipulate (e.g., expand) the dispersed spectral band 165 such that a size of the dispersed spectral band 165 in the band separation direction matches a size of the detector area 120 along the band separation direction. In this way, the spatial arrangement of the dispersed spectral bands 165 at the detector area 120 can be controlled so as to maximize the use of a particular detector geometry (e.g., a rectangular 2D detector array 118).

The detector array 118 comprises one or more detector areas 120 on which one or more of the spectral bands 165 are imaged. In some implementations, as indicated in FIG. 1B, the detector area 120 may comprise a plurality of detector areas 120 that are stacked along the band separation direction. In some implementations, the detector array 118 may comprise a 2D array (e.g., a 2D array of detector areas 120). Additionally, or alternatively, the detector array 118 may comprise a plurality of 1D detector arrays (e.g., a plurality of 1D detector arrays that are stacked along the band separation direction). Such an implementation may, for example, extend detection capabilities (e.g., a spectral range, a spectral resolution, a detection dynamic range, a detection sensitivity, or the like) of the optical device 110. In some implementations, the detector array 118 may comprise a single photon avalanche diode (SPAD) array (e.g., a high dynamic range and sensitivity, high temporal resolution (sub-nanosecond) SPAD array). Additionally, or alternatively, the detector array 118 may comprise an array of time-resolved photon counting detectors (e.g., an array of areas capable of associating a time stamp with each photon detected by a given area). Such detectors may also be referred to as time-binned photon counting detectors or time-tagged photon counting detectors. Alternatively, the detector array 118 may comprise a detector array comprising photon detectors that use another type of technology (e.g., an array of photon detectors that may or may not include time-resolved photon counting detectors). In some implementations, a size of a first detector area 120 of the plurality of detector areas 120 is different from a size of a second detector area 120 of the plurality of detector areas 120. In some implementations, a detector area 120 of the detector array 118 could be used for multiple spectral bands 165. Reuse of a detector area 120 may be enabled, for example, by multiplexing in the time domain in combination with an active element capable of selecting a spectral band 165 that is manipulated and imaged onto the given detector area 120 at a given point in time.

In some implementations, a size of a first detector area 120 of the detector array 118 in the dispersion direction matches a size of a second detector area 120 of the detector array 118 in the dispersion direction, and a size of the first detector area 120 in the band separation direction is different from a size of the second detector area 120 in the band separation direction. In such an implementation, greater sensitivity is provided for a spectral band 165 imaged to the first detector area 120 with the comparatively larger size. In this way, the dynamic range and the sensitivity desired for measurement of each spectral band 165 can be set freely and independently of the other spectral bands 165 by controlling the “height” in the band separation direction that each spectral band 165 is imaged onto the detector array 118. While increasing the size of the detector area 120 illuminated by a particular spectral band 165 does not change the total amount of photons in that spectral band 165, the size increase increases the dynamic range and sensitivity that can be achieved for that spectral band 165 (e.g., by reducing the impact of reset “dead-time” that occurs after a pixel detection event in SPAD arrays) and increases the saturation limit of the detector array 118 for wavelengths in that spectral band 165 because the photons are spread to more pixels of the detector array 118. In some implementations, a given detector area 120 of the detector array 118 may be associated with a different respective spectral band 165. In some implementations, a given detector area 120 may comprise multiple pixels in the dispersion direction and multiple pixels in the separation direction (e.g., to avoid saturation and allow more detector counts per pulse, to improve signal quality, or the like). In some implementations, pixels of a given detector area 120 may be grouped into a plurality of macro-pixels (e.g., to adjust a trade-off between detection efficiency and spectral resolution).

In some implementations, the arrangement of the spectral bands 165 on the detector areas 120 of the detector array 118 may be (e.g., dynamically) controlled such that a particular spectral band 165 is incident on a particular detector area 120 or such that the particular spectral band 165 is incident in a detector area 120 that is away from a particular detector area 120. For example, the spectral bands 165 may be arranged such that a spectral band 165 of particular interest is incident on a detector area 120 corresponding to a first row of the detector array 118 to enable a “quick” read from the detector array 118. In some implementations, the detector area 120 may support segmentation into particular blocks of pixels, with a programmable read-out timing per block of pixels. As another example, if a particular pixel of the detector array 118 is experiencing noise or another performance issue, then the spectral band 165 of particular interest may be arranged so as to be incident on a detector area 120 that is not near the particular pixel experiencing the performance issue. In some implementations, arrangements of the spectral bands 165 on the detector areas 120 such as those described in the above examples can be configured dynamically, meaning that the arrangement of the spectral bands 165 on the detector areas 120 can be updated, modified, or altered during operation of the optical device 110 (e.g., based on control signals provided by the controller 122). In some implementations, such dynamic control can be achieved by, for example, adjusting a position, alignment, rotation, or other characteristic of one or more elements of the optical system 100, such as the collecting element 104, the filter 106, the separating element 112, the dispersive element 114, one or more optical elements 116, the detector array 118, one or more detector areas 120, and/or one or more other elements associated with manipulating or directing light (e.g., one or more directing elements, one or more lenses, or the like) in the optical system 100.

In the example shown in FIG. 1B, the separating element 112 provides four spectral bands 165 (i.e., four sub-spectra), three of which (e.g., spectral band 165a, spectral band 165c, and spectral band 165d) are directed to the dispersive element 114 to be dispersed and then manipulated by respective optical elements 116 for imaging with three different geometries (e.g., different heights of each spectral band 165). An example of a resulting arrangement of the optical signal 160 into these three spectral bands 165 with different properties (e.g., height-dependent dynamic range and sensitivity, spectral range, spectral width covered, spectral resolution) is illustrated in FIG. 1B and with Table 1 below. Notably, in this example, spectral band 165b is not imaged at the detector array 118. That is, in some implementations, at least one spectral band 165 of the plurality of spectral bands 165 may not be imaged onto any detector area 120 of the detector array 118. Such an implementation may be used when, for example, some portion (e.g., spectral band 165b) of the full spectrum does not need to be measured or detected. In some implementations, the capability to have such spectral gaps in detection at the detector array 118 may enable enhancement of one or more other attributes of the detected spectral bands 165 (e.g., increased resolution, redundancy, read-out speed, or the like). Thus, in some implementations, a spectrum formed by a sum of a set of spectral bands 165 that is imaged on the detector array 118 is non-continuous (e.g., includes one or more spectral gaps). In some implementations, an optical power of a given spectral band 165, of the plurality of spectral bands 165, at the detector array 118 is more than 90% of an optical power of the spectral band 165 prior to the separating element 112. That is, spectral bands 165 can be imaged at the detector array 118 with no or minimal loss of power (other than power loss caused by non-idealities of optical components performing the separating function).

Notably, because spectral bands 165 can be stacked when imaged onto the detector array 118 (e.g., a 2D detector array), an angular range required of elements and optics of the optical device 110 is significantly reduced in the dispersion direction (e.g., as compared to a conventional device that uses a comparatively longer 1D detector). This reduces the physical size of the optical device 110, thereby enabling a more compact optical engine. Further, the optical device 110 can be applied to many existing spectroscopy techniques. For example, the optical device 110 may be used for Raman and fluorescent spectroscopy, and reading time of the detector array 118 may be time-gated and/or correlated with exposure of the sample 155 to the excitation light 150.

Further, according to the techniques described herein, a given spectral band 165 can in some implementations be directed to any detector area 120 of the detector array 118. An active area of the detector array 118 need not have the same dimension as an area given by a sum of areas of all of the spectral bands 165 to be detected at the plane of the detector array 118. In some implementations, the spectral bands 165 can be arranged to fit a width of the active area of the detector array 118, and a scanning mechanism can be used to move the spectral bands 165 in the band separation direction to fall onto the detector area 120 or to move the detector array 118 in the band separation direction to fall in the field of view of the desired spectral band(s) 165. This may enable the use of a reduced-size detector array 118 (e.g., a reduced size 1D array or a 2D array with fewer detector regions) whose width is set by the width of a single spectral band 165 to measure the entire spectrum (e.g., a sum of all the spectral bands 165).

In some implementations, one or more elements of the optical device 110 can be statically configured (e.g., using conventional optics). Additionally, or alternatively, one or more elements of the optical device 110 can be dynamically configured to, for example, allow a number of spectral bands 165 generated, a spectral range of each spectral band 165, a dynamic range and sensitivity (or height on the detector array 118) applied to each spectral band 165, and/or a location at which each spectral band 165 is imaged on the detector array 118 to be dynamically configured. A dynamic configuration may allow different spectral bands 165 from different pulses to be imaged onto the detector array 118. In some implementations, read-out of one or more detector areas 120 of the detector array 118 can be performed using a variety of techniques, such as using a global shutter or a rolling shutter. Further, in some implementations, one or more spectral bands 165 may be removed by the separating element 112 (e.g., as illustrated in FIG. 1B). Additionally, or alternatively, one or more other elements of the optical device 10 may be configured to remove one or more spectral bands 165 (e.g., such that the one or more spectral bands 165 are not imaged onto the detector array 118), such as the dispersive element 114 or one or more optical elements 116.

An optical resolution is given by the dispersive element 114 (e.g., a grating resolution) regardless of characteristics of the detector array 118. A detector resolution is given by the detector array 118 (e.g., a size of pixels of the detector array 118) and is similarly independent of the dispersive element 114. The system resolution combines the optical resolution and the detector resolution. In the optical device 110, a best result that can be achieved is the optical resolution since, even if a better detector resolution is provided, the detector array 118 cannot sample at a higher resolution than provided by the dispersed spectral bands 165 provided by the dispersive element 114. In practice, a goal is to match the detector resolution to the optical resolution to avoid degrading the optical resolution without having unnecessary pixels. In some implementations, a spectral resolution of a first spectral band 165 of the plurality of spectral bands 165 is different from a spectral resolution of a second spectral band 165 of the plurality of spectral bands 165.

Spectral range is given by the range of wavenumber or wavelength that is included within a particular spectral response, signal, band, or sub-spectra. Spectral range is similar to a bandwidth in wavelengths. In the case of Raman spectroscopy, an example spectral range of the optical signal 160 may be more than approximately 100 nm (in wavelength) or more than approximately 3000 cm−1 (in wavenumbers). Further, an example spectral range of a given spectral band 165 may be between approximately 400 and 700 wavenumbers. In some implementations, a spectral range of the first spectral band 165 of the plurality of spectral bands 165 may be different from a spectral range of a second spectral band 165 of the plurality of spectral bands 165.

Dynamic range is a range of values that can be reported from a set of pixels of the detector array 118 with respect to a particular wavelength/wavenumber in a spectral band 165. In some implementations, by increasing the number of pixels per wavelength/wavenumber, the dynamic range for that wavelength/wavenumber can be increased (e.g., by reducing the impact of reset “dead-time” that occurs after a pixel detection event in SPAD arrays).

Returning to FIG. 1A, the controller 122 is an element to obtain one or more read-out signals from the detector array 118. A read-out signal is a signal corresponding to a quantity of photons detected by a given detector area 120 of the detector array 118 during an acquisition window associated with the given detector area 120. Here, each detector area 120 may be associated with a respective spectral band 165 and, therefore, a read-out signal associated with a given detector area 120 may correspond to a quantity of photons for the spectral band 165 associated with the given detector area 120 for a given time window. In some implementations, in association with obtaining one or more read-outs signal, the controller 122 may be configured to coordinate operation of the optical source 102 and operation of one or more other elements of the optical system 100. For example, the controller 122 may be configured to coordinate operation of the optical source 102 and operation of the detector array 118 such that timing of receipt of an optical signal 160 (in the form of optical pulses or bursts of photons) from the sample 155 in response to the excitation light 150 provided by the optical source 102 is synchronized with timing of an acquisition window of one or more detector areas 120 of the detector array 118 from which one or more read-out signals are to be obtained. In some implementations, such coordination may involve one or more other elements of the optical system 100. For example, in the case of a collecting element 104 comprising a mechanical moving mirror or a shutter, the controller 122 may be configured to control the collecting element 104 so as to enable scanning or dithering of the excitation light 150 over a region of the sample 155. As another example, the controller 122 may be configured to control a scanning element (e.g., a mechanical moving mirror) that enables direction of the optical signal 160 toward the one or more detector areas 120 during the acquisition window. In some implementations, this scanning element may be separate from the collecting element 104 (e.g., the scanning element may be included in the optical device 110 on the detection optical path after the slit 108). Such an implementation may be used when, for example, the optical path of the optical signal 160 and the optical path of the excitation light 150 are separate independent optical paths or when the optical path of the optical signal 160 and the optical path of the excitation light 150 share a subset of optical elements of the optical system 100. Alternatively, the scanning element may in some implementations be included in or integrated with the collecting element 104 (e.g., the collecting element 104 may enable both scanning or dithering of the excitation light 150 over a region of the sample 155 and direction of the optical signal 160 toward the one or more detector areas 120, as controlled by the controller 122). Such an implementation may be used when, for example, the collecting element 104 is on both the optical path of the optical signal 160 and the optical path of the excitation light 150.

In practice, separating Raman and fluorescence signals requires synchronization and timing down to a sub-nanosecond resolution, meaning that signal delays need to be accounted for. Such signal delays can result from, for example, laser cavity dynamics which cause delay or jitter between electrical drive signals and emission of optical pulses, propagation delay of transmitted optical pulses to and from the sample 155, timing of detection (e.g., SPAD temporal bins) relative to laser pulse arrival at the detector array 118, or timing of enabling photon detection. In some implementations, the controller 122 can be configured to set (optimal) operating parameters and synchronization with scanning or attenuating elements of the optical system 100 so as to avoid unwanted effects, such as damage to or heating of sample 155 (which can change or shift the measured spectrum), detector saturation, or photo bleaching (which can change the measured spectrum).

In some implementations, the controller 122 may obtain a plurality of read-out signals, where each read-out signal is obtained during a different acquisition window of a plurality of acquisition windows. That is, in some implementations, the controller 122 may be configured to read one spectral band 165 at a time from the detector array 118 (e.g., in a rolling window fashion). In some implementations, the controller 122 may control lengths of a given acquisition window such that lengths may differ among the plurality of acquisition windows. For example, a length of time of a first acquisition window associated with a first read-out signal may be different from a length of time of a second acquisition window associated with a second read-out signal. In this way, an amount of time used for measurement of a given spectral band 165 can be controlled (e.g., increased relative to others) so as to enable improved measurement for comparatively higher priority spectral bands 165. Additionally, or alternatively, the controller 122 may obtain a plurality of read-out signals, where each read-out signal is obtained concurrently during a single acquisition window (e.g., in a global shutter fashion).

In some implementations, the controller 122 may be configured to coordinate sampling of a read-out signal, of the one or more read-out signals, with excitation of the sample 155 so as to enable time-resolved Raman spectroscopy. Additionally, or alternatively, the controller 122 may be configured to coordinate time sampling of a read-out signal, of the one or more read-out signals, with excitation of the sample 155 to enable time-resolved Fluorescence spectroscopy. Thus, in some implementations, the optical system 100 can be configured for use in, for example, a time-gated Raman spectroscopy application (e.g., time-resolved measurement and temporal discrimination of Raman and Fluorescence signals), a time-resolved fluorescence spectroscopy application (e.g., fluorescence lifetime imaging spectroscopy (FLIM) or the like), a dynamic real-time SORS application, a LIBS application, or a photo-acoustic spectroscopy application, among other examples.

In some implementations, the controller 122 may be configured to perform synchronization to account for timing jitter in the excitation light 150. For example, the controller 122 may in some implementations use a separate optical detector to detect timing of pulses of the excitation light 150 and control timing of the detector array 118 accordingly. In some implementations, such synchronization can be performed in addition to or in alternative to timing jitter control as performed by the optical source 102.

In some implementations, the optical system 100 may comprise one or more other elements not shown in FIGS. 1A-1B. For example, the optical system 100 may in some implementations include a scanning element to dither or scan the excitation light 150 incident on the sample 155. In one example, the scanning element may be a MEMS device with 1D or 2D scanning capability. In some implementations, the scanning element may be integrated with the collecting element 104. In some implementations, such a scanning element could also be used to disable the laser output, meaning that that scanning element would not provide scanning but would be “parked” at a position (or state) that prevents the excitation light 150 from exiting an enclosure of the optical system 100.

As another example, the optical system 100 may in some implementations comprise a shifting element to dynamically adjust a spatial separation between an illumination optical path of the optical system 100 (e.g., a path via which the excitation light 150 is provided to the sample 155) and a detection optical path of the optical system 100 (e.g., a path on which the optical signal 160 is provided to the optical device 110). In one example, a shifting element can be included (e.g., inside the optical system 100 or in an external probe attachment) and can be used to enable dynamic, spatially-resolved Raman and fluorescence spectroscopy. With such a capability, the illumination optical path and/or the detection optical path can be dynamically shifted in position on the sample 155. This dynamic change of the separation between the illumination optical path and the detection optical path allows the probe of Raman and fluorescence signals from different depth layers of the sample 155 and offers measurement capabilities and attributes similar to those of the SORS technique, while also allowing a dynamic change of the location of the probed areas or layers of the sample 155. In some such implementations, the shifting element may be integrated with the collecting element 104 and/or with a scanning element that is to dither or scan the excitation light 150 incident on the sample 155, or may be a separate element.

As another example, the optical system 100 may in some implementations comprise a sampling interface mounted on a hermetic package that houses one or more elements of the optical system 100 (e.g., the optical device 110). In some implementations, the sample interface may enable, for example, a fiber probe, an optical relay system (e.g., to adjust beam size and working distance), or an external SORS application.

In some implementations, the optical system 100 described herein differs from conventional solutions in that the optical system 100 enables (1) simultaneous time-resolved measurement as well as temporal discrimination of Raman and fluorescence, (2) increased sensitivity and measurement speed, (3) increased resolution and spectral range, (4) improved size, weight, and power (SWAP), (5) mitigation of sample damage, and (6) extension to dynamic spatially offset Raman spectroscopy.

With respect to point (1), when an optical pulse is incident on a material, both Raman and fluorescence signals are produced. While Raman scattering has a short lifetime (e.g., on the order of sub-picoseconds (ps)), the fluorescence process involves real electronic excited states with finite measurable lifetimes (e.g., on the order of many ps to microseconds (μs)). Thus, when using optical pulses as the source of the excitation, Raman and fluorescence signals can be separated in the temporal domain. In some implementations, time-resolved measurement and temporal discrimination of Raman and fluorescence signals can be achieved by the optical system 100 through the use of a detector array 118 in the form of a high sensitivity, high temporal resolution (e.g., sub-ns) 2D SPAD array detector that enables both time-binning and time-gating detection, an example of which is illustrated in FIG. 1C. As shown in FIG. 1C, time bins carry both Raman and fluorescence signals with relative amplitude changing over time, which allows the measurement of both signals simultaneously. Analysis of early time bins (e.g., coincident with the pulsed laser excitation) reveals the Raman signal with the largest amplitude-to-background ratio, which is, in effect, a fluorescence ratio. At later times (e.g., after pulsed laser excitation), time bins have a negligible amount of, or no, Raman photons, and the detected signal is dominated by fluorescence, which enables time-resolved fluorescence spectroscopy. In some implementations, as described above, the controller 122 may be configured to coordinate operation of one or more elements of the optical system 100. Thus, the controller 122 may in some implementations coordinate operation of one or more elements of the optical system 100, such as the optical source 102 and the detector array 118, to enable time-resolved measurement and temporal discrimination of Raman and fluorescence signals. In some implementations, the optical system 100 can use time-gating to reject signals outside of a set detection window (e.g., where a SPAD is disabled).

With respect to point (2), increased sensitivity and measurement speed can be enabled by a high repetition rate laser combined with the detector array 118 (e.g., a high sensitivity SPAD array) and the time-binned/time-gated detection (e.g., which suppresses fluorescence background and improves an SNR). Here, since the SNR scales with a square-root of the number of detected photons (i.e., optical pulses), increasing a laser repetition rate increases the SNR for constant measurement time (or, conversely, increases measurement speed for constant SNR). A higher SNR leads to higher sensitivity to detect weak Raman signals which otherwise would be obscured by a background signal (i.e., a fluorescence signal). In some implementations, increased sensitivity and measurement speed can be enabled by the optical system 100 through the splitting of the optical signal 160 into spatially-separated spectral bands 165, which are imaged onto the detector array 118 in a 2D arrangement with no significant loss of power, as described herein.

With respect to point (3), for the same size as conventional solutions, the optical system 100 can achieve a higher resolution and/or cover a larger spectral range. Alternatively, the optical system 100 described herein can achieve the same performance as the conventional solutions, but within a smaller footprint. This is enabled by the spectral banding optical design that separates the optical signal including the full spectral range into spectral bands 165 and rearranging the spectral bands 165 to maximize usage of an active area of the detector array 118, as described herein (e.g., in combination with a capable 2D SPAD array detector). As described herein, the spectral bands 165 can be rearranged in a variety of ways depending, for example, on a spectral range target and/or a spectral resolution target. In general, the number of spectral bands 165 can be varied, and a spectral range covered or a spectral range of each spectral band 165 can be set freely and independently of the other spectral bands 165 (e.g., in order to meet a performance target).

With respect to point (4), size improvement may be defined as a reduction in a footprint of the optical system (e.g., including collection optics and the spectrograph), which may be enabled by the spectral banding optical design approach described herein. As a consequence of the reduced footprint, sizes of optical and mechanical components can also be reduced, thereby reducing overall weight of the spectroscopy engine. The latter may also lead to reduced power consumption as it may take less time to set or maintain a temperature of a smaller footprint and/or reduced weight optical system. In some implementations, an optical layout of the optical system 100 may serve to enable reduction of the footprint or the weight of the optical system 100. For example, the layout of the optical system 100 may be configured such that one or more elements are used on both a detection optical path (e.g., an optical path of the optical signal 160) and an illumination optical path (e.g., an optical path of the excitation light 150), meaning that the detection optical path and the illumination optical path at least partially overlap. Such an optical layout enables a smaller footprint through the use of the same physical space for some portion of multiple optical paths and can also enable a reduced weight through the use of one or more of the same optical elements on the multiple optical paths. Other components of the system contributing to improved SWAP (size, weight, and power) may include the laser source and the detector array. In some implementations, the laser source may be a highly integrated compact microchip device delivering, for example, optical pulses at a particular wavelength (e.g., 532 nm) with a high repetition rate (e.g., at least approximately 500 kilohertz (kHz)), a low energy (e.g., less than approximately 100 nanojoules (nJ)), and a narrow linewidth (e.g., less than approximately 0.1 nm). In some implementations, the detector array may be a high sensitivity 2D SPAD array having a pixel size and a pixel count that enables high (e.g., less than approximately 10 cm⁻¹ wavenumber) spectral resolution. In some implementations, a pixel size and 2D array geometry may be selected so as to reduce the overall system footprint. Furthermore, if configured for operation in a visible wavelength, SPAD detectors may be used at near maximum efficiency and minimum noise, meaning that thermal cooling may be required less frequently (e.g., as compared to other Raman spectroscopy instruments). As a result, power consumption can be reduced.

With respect to point (5), mitigation of sample damage can be achieved through the use of low energy pulses, a detector array 118 in the form of a high-sensitivity SPAD detector, and a beam scanning mechanism, such as a MEMS scanner. Further, by separating spectral bands 165 with no power loss (other than power loss caused by non-idealities of optical components), optimization of detection in a given spectral band 165 is increased and an SNR is increased, meaning that lower power illumination can be used to illuminate the sample 155, thereby reducing a likelihood of damage the sample 155.

With respect to point (6), a shifting element can be integrated into the optical system 100 or within an external probe attachment, and can be used to enable dynamic, spatially-resolved Raman and fluorescence spectroscopy, as described above.

As indicated above, FIGS. 1A-1C are provided as examples. Other examples may differ from what is described with regard to FIGS. 1A-1C. Further, the number and arrangement of elements shown in FIGS. 1A-1B are provided as examples. In practice, there may be additional elements, fewer elements, different elements, or differently arranged elements than those shown in FIGS. 1A-1B. For example, the physical layout of the optical system 100 (e.g., a layout of the optical source 102, the collecting element 104, the filter 106, the optical device 110, or the like) provides the functionality described herein using free-space optics. A power and pulse energy of the optical source 102 may be relatively high, and the use of free-space optics is advantageous with respect to power handling. Further, free-space optics is efficient with respect to collection of relatively weak reflected Raman signals. However, in some implementations, the physical layout of the optical system 100 may be designed to provide the functionality described herein in another manner, such as by using fiber-based or waveguide-based optics (rather than or in addition to free-space optics). In some implementations, the selection of the technique used to provide the functionality of the optical system 100 may be a design requirement in a given application, such as optical performance, size, power consumption, mechanical stability, or the like. Furthermore, two or more elements shown in FIGS. 1A-1B may be implemented within a single element, or a single element shown in FIGS. 1A-1B may be implemented as multiple, distributed elements. Additionally, or alternatively, a set of elements (e.g., one or more elements) shown in FIGS. 1A-1B may perform one or more functions described as being performed by another set of elements shown in FIGS. 1A-1B.

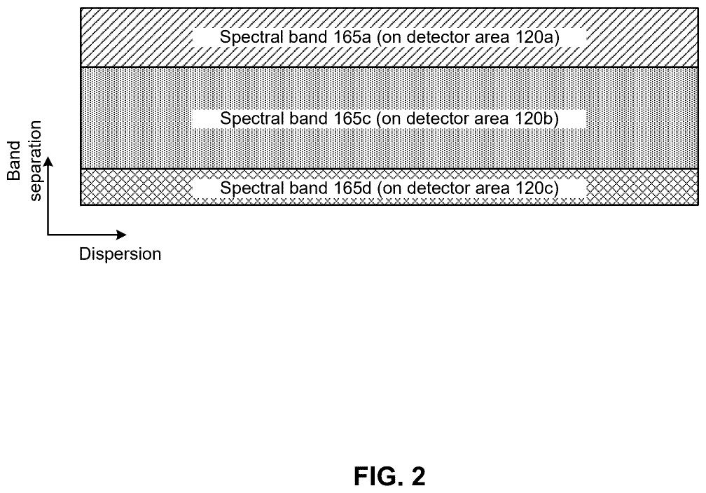

FIG. 2, in combination with Table 1 (below), illustrates an example associated with the optical device 110 that provides flexible segmentation and arrangement of a full spectrum. In the example shown in FIG. 2, the spectral bands 165 are arranged so that the spectral bands 165 are imaged in a stack in the band separation direction (e.g., a direction perpendicular to the dispersion direction) at the detector array 118. As noted above, the spectral bands 165 can be arranged in a variety of ways depending on, for example, a spectral range, a spectral resolution, and/or a detection dynamic range and sensitivity target. In some implementations, a number and areas of spectral bands 165 can be varied, and each spectral band 165 spectral range, resolution, dynamic range, and/or sensitivity can be set independently of those of the other spectral bands 165 (e.g., for the purpose of meeting specific performance targets for a given application). For example, portions of the full spectrum that do not need to be measured or detected (e.g., spectral band 165b) can in some implementations be skipped (e.g., avoided or rejected). As another example, specific pixels or detector areas 120 of the detector array 118 that cannot or should not be used can be avoided.

TABLE 1

| | | | Band | | | |
|---|---|---|---|---|---|---|
| | Relative | | height | | | |
| | importance | | (pixels) | | Spectral band | Spectral |
| Spectral | to sample | Detector | (size of | Spectral range | width | resolution |
| band # | identification | area # | sensor) | (wavenumbers) | (wavenumbers) | (wavenumbers) |
| 165a | Normal | 120a | 200 | 400-700 | 300 | 1.5 |
| 165b | Not | N/A | N/A | 700-1100 | 400 | N/A |
| | Monitored | | | | | |
| 165c | High | 120b | 400 | 1100-1600 | 500 | 0.5 |
| 165d | Low | 120c | 100 | 0-400 | 400 | 4 |

Table 1 presents a numeric example illustrating attributes of the different spectral bands 165 imaged on a 2D detector array 118 comprising three detector areas 120 as illustrated in FIG. 2. In this example, a height of an example detector area 120 is 700 pixels and an example spectral range (expressed as spectral shift from excitation wavelength) is 0 to 1600 wavenumbers. Here, one fraction of the full spectrum, spectral band 165b, is not measured or monitored and therefore is not imaged onto the detector array 118, while the remainder of the full spectrum is divided into spectral band 165a, spectral band 165c, and spectral band 165d with different spectral ranges, resolution, dynamic ranges and sensitivities (e.g., scaling with height on the detector array 118, referred to as band height in Table 1) and imaged onto different detector areas 120 of the detector array 118.

As indicated above, FIG. 2 is provided as an example. Other examples may differ from what is described with regard to FIG. 2.

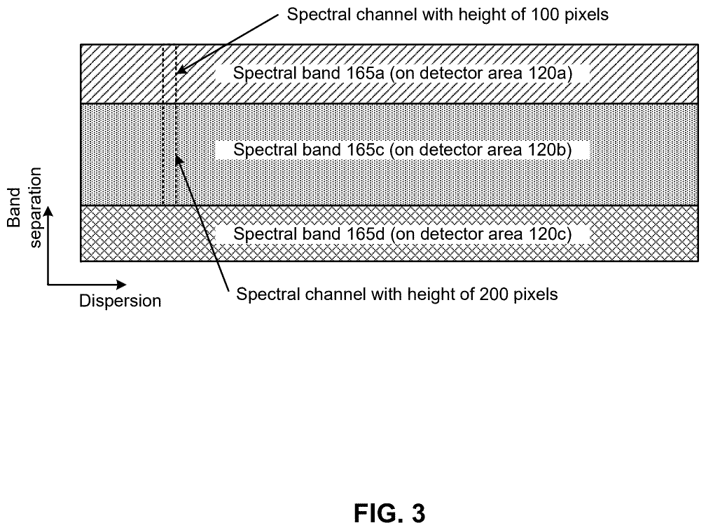

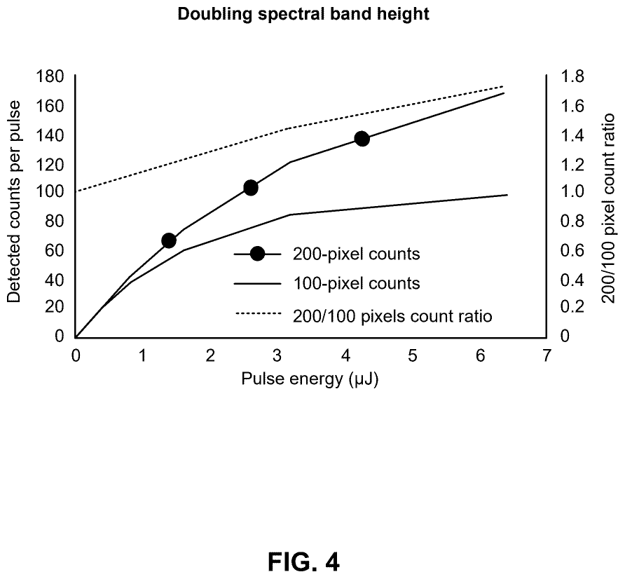

FIGS. 3 and 4 are diagrams associated with increasing a dynamic range and sensitivity as enabled by the optical device 110. In some implementations, a dynamic range and sensitivity can be increased without changing front-end light collection and spectral splitting. In one example implementation, back-end imaging optics (e.g., one or more optical elements 116) may be designed such that energy in one spectral band 165 is imaged with a different, larger, height on the detector array 118, at the expense of reduced height or number of other spectral bands 165 for a fixed-size detector area. Alternatively, in another example implementation, two or more spectral bands 165 can be made identical (e.g., spectral band 165a and spectral band 165d in FIG. 3), and power in those spectral bands 165 can be equally split.

In the example detector array 118 illustrated in FIG. 3, spectral band 165c has twice the height of spectral band 165a (e.g., 200 pixels versus 100 pixels) at the detector array 118 (e.g., a height of the detector area 120 at which the spectral band 165c is imaged is twice that of the detector area 120 at which the spectral band 165a is imaged). Here, if all spectral bands 165 have equal energy (e.g., power or throughput), then spectral band 165c would have a pulse energy per pixel reduced by a factor of 2 as compared to spectral band 165a (and spectral band 165d). The impact of reducing energy density (e.g., energy per pixel) on the detector array 118 is calculated in the diagram shown in FIG. 4 for two channel sizes: a spectral channel of a particular width and a height of 100 pixels and a spectral channel with the particular width and a height of 200 pixels. As shown in FIG. 4, the taller channel (i.e., the spectral channel with the height of 200 pixels) has a larger dynamic range for count detection, which leads to increased sensitivity. In the diagram shown in FIG. 4, if the pulse energy were further increased, the detected counts per pulse would eventually saturate the detector array 118, meaning that the detector array 118 could not detect more counts despite increases in pulse energy. In some implementations, by increasing the height (e.g., and number of pixels) allotted to a given spectral band 165, the sensitivity and saturation limit can be increased.

In some implementations, a first spectral band 165x with a comparatively smaller bandwidth can be imaged on a first detector area 110x of the detector array 118, and a second spectral band 165y with a comparatively larger bandwidth can be imaged on a second detector area 110y of the detector array 118, while a total width and pixel size (i.e., resolution) of the first detector area 110x in the dispersion direction matches a total width and pixel size (i.e., resolution) of the second detector area 110y in the dispersion direction. In this way, when the optical resolution of a first spectral band 165x matches the optical resolution of a second spectral band 165y, the first spectral band 165x may be provided with a higher spectral resolution than the second spectral band 165y (e.g., because each detector pixel receives fewer wave numbers for the first spectral band 165x with the comparatively smaller bandwidth).

As indicated above, FIGS. 3 and 4 are provided as examples. Other examples may differ from what is described with regard to FIGS. 3 and 4.

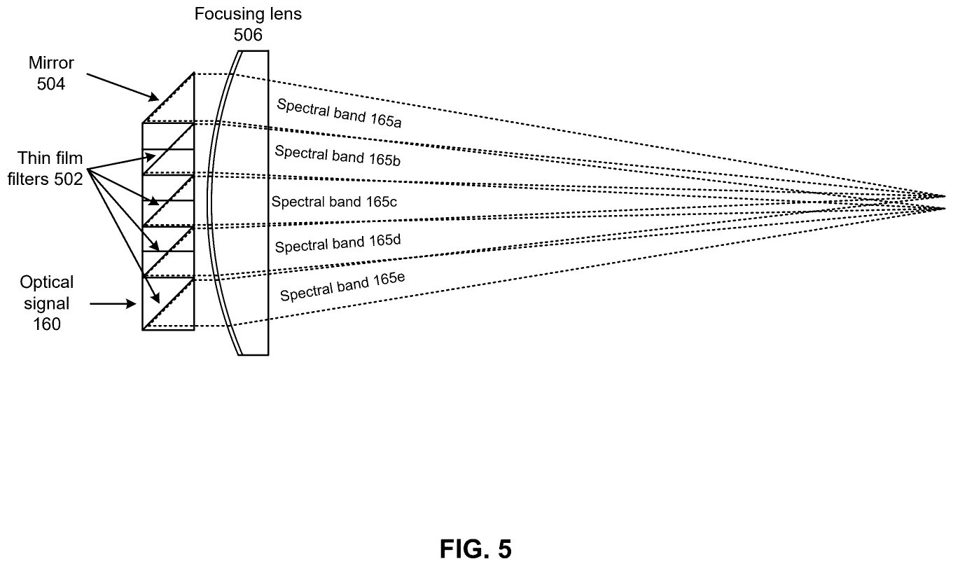

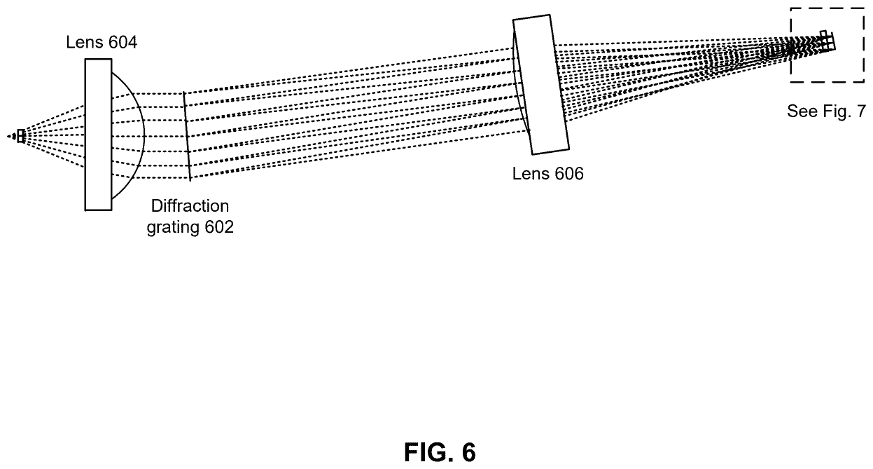

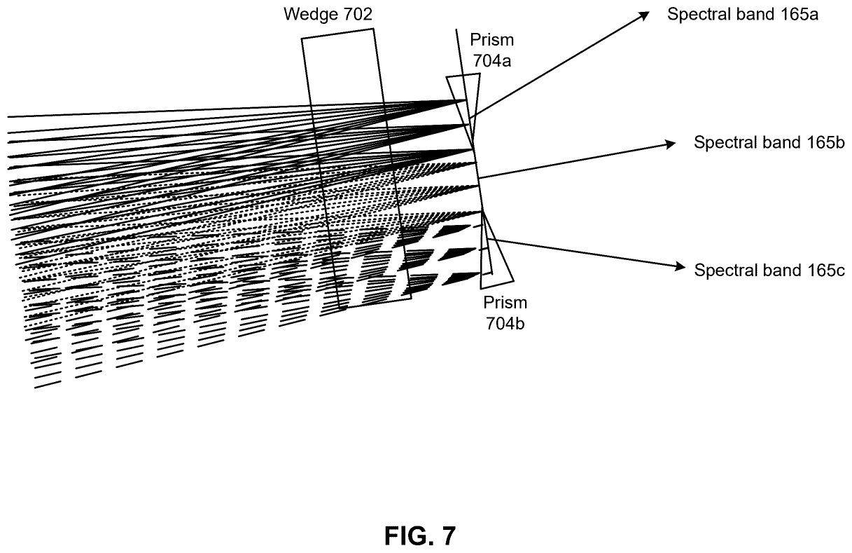

FIGS. 5-7 are diagrams illustrating example implementations of a separating element 112 described herein. In some implementations, as noted above, the separating element 112 may include one or more elements capable of spatially or angularly separating the optical signal 160 into multiple spectral bands 165 such that each spectral band 165 is spatially or angularly separated from other spectral bands 165. In some implementations, the separating element 112 may comprise a plurality of thin film interference filters, each associated with a different spectral band 165 of the plurality of spectral bands 165. FIG. 5 is a diagram illustrating an example implementation of a separating element 112 comprising a plurality of (e.g., four) thin film interference filters 502. Additionally, or alternatively, these may comprise a diffraction grating. FIGS. 6 and 7 are diagrams illustrating an example implementation of a separating element 112 comprising a diffraction grating 602. Additionally, or alternatively, the separating element 112 may comprise one or more other types of optical elements.

In some implementations, light of the optical signal 160 with a wavelength near a boundary between two spectral bands 165 may be split by the separating element 112 such that respective portions of the light go into multiple spectral bands 165. Thus, in some implementations, a spectral component at or near a boundary between a first spectral band 165 of the plurality of spectral bands 165 and a second spectral band 165 of the plurality of spectral bands 165 may split such that a first portion of the spectral component is in the first spectral band 165 and a second portion of the spectral component is in the second spectral band 165. Here, a sum of the power of the first portion and a power of the second portion is a total power of the spectral component.

In the example shown in FIG. 5, the optical signal 160 includes a full spectrum originating from the sample 155 (e.g., as in FIG. 1B). Here, each thin film interference filter 502 reflects only a fraction (e.g., a spectral band 165) of the full spectrum and transmits the remainder. In some implementations, as illustrated in FIG. 5, a sequence of multiple (e.g., four) interference filters 502, followed by a mirror 504, divides the full spectrum into multiple (e.g., five) spatially separated spectral bands 165, which are then incident on a focusing lens 506 to transform the spatial separation (e.g., offset) into an angular separation (e.g., angle) of the different spectral bands 165. The spectral bands 165 can then be imaged onto a plane for further optical processing. In the context of the optical device 110 described in FIG. 1B, the spatially/angularly separated spectral bands 165 are then directed to the dispersive element 114.

In the examples shown in FIGS. 6 and 7, the optical signal 160, including the full spectrum originating from the sample 155 (e.g., as in FIG. 2), is collimated by a lens 604 and then directed onto a diffraction grating 602 which separates the incoming light into different spectral components (e.g., wavelengths). The diffracted light emerging from the diffraction grating 602 is then focused by a lens 606 and imaged to produce spatially and angularly separated spectral bands 165. The imaging system shown in FIG. 7 includes a wedge 702 and prisms 704a and 704b that serve to change optical path lengths and propagation angles of the beams of the spectral bands 165 in such a way that the emerging spectral beams appear to be coming from a single focal plane, but from different angles (e.g., similar to what is achieved in the example shown in FIG. 5). In the context of the optical device 110 described in FIG. 1B, the spatially/angularly separated spectral bands 165 are then directed to the dispersive element 114.

As indicated above, FIGS. 5-7 are provided as examples. Other examples may differ from what is described with regard to FIGS. 5-7. The number and arrangement of elements shown in FIGS. 5-7 are provided as an example. In practice, there may be additional elements, fewer elements, different elements, or differently arranged elements than those shown in FIGS. 5-7. Furthermore, two or more elements shown in FIGS. 5-7 may be implemented within a single element, or a single element shown in FIGS. 5-7 may be implemented as multiple, distributed elements. Additionally, or alternatively, a set of elements (e.g., one or more elements) shown in FIGS. 5-7 may perform one or more functions described as being performed by another set of elements shown in FIGS. 5-7.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., an optical element or one or more optical elements) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
an optical source to provide an excitation light;
a collecting element to:
direct an optical signal, received from a sample in response to incidence of the excitation light on the sample, to an optical device;
the optical device comprising:
a separating element to separate the optical signal into a plurality of spectral bands that are spatially or angularly separated along a band separation direction,
wherein spectral ranges differ among each spectral band of the plurality of spectral bands,
a dispersive element comprising a plurality of dispersive regions, wherein a dispersive region of the plurality of dispersive regions is to disperse spectral components of a spectral band, of the plurality of spectral bands, along a dispersion direction to form a dispersed spectral band,
a plurality of optical elements, wherein an optical element of the plurality of optical elements is to manipulate the dispersed spectral band in association with imaging the spectral band onto a detector area of a detector array, and
the detector array comprising the detector area; and
a controller to obtain one or more read-out signals from the detector array.

2. The optical system of claim 1, wherein the optical source is a pulsed laser source such that the excitation light comprises optical pulses with a high repetition rate, a low energy, and a narrow linewidth.

3. The optical system of claim 1, wherein the optical source is configured to reduce timing jitter in the excitation light or to perform synchronization to account for jitter in the excitation light.

4. The optical system of claim 1, wherein the optical source is one of a plurality of optical sources, each configured to at least one of: emit at a different wavelength, generate excitation light with different pulse characteristics or operate in a different operation mode.

5. The optical system of claim 1, further comprising a scanning element to dither or scan the excitation light incident on the sample.

6. The optical system of claim 1, wherein the one or more read-out signals comprise a plurality of read-out signals, each to be obtained during a different acquisition window of a plurality of acquisition windows.

7. The optical system of claim 6, wherein a length of time of a first acquisition window, of the plurality of acquisition windows, is different from a length of time of a second acquisition window of the plurality of acquisition windows.

8. The optical system of claim 1, wherein the one or more read-out signals comprise a plurality of read-out signals, each to be obtained concurrently during a single acquisition window.

9. The optical system of claim 1, wherein the controller is configured to perform synchronization to account for timing jitter in the excitation light.

10. The optical system of claim 1, wherein the controller is configured to coordinate sampling of a read-out signal, of the one or more read-out signals, with excitation of the sample to enable time-resolved Raman spectroscopy.

11. The optical system of claim 1, wherein the controller is configured to time sampling of a read-out signal, of the one or more read-out signals, with excitation of the sample to enable time-resolved Fluorescence spectroscopy.

12. The optical system of claim 1, wherein the detector array is partitioned into a plurality of detector areas, each being associated with a different spectral band in the plurality of spectral bands.

13. The optical system of claim 1, wherein the detector area comprises multiple pixels in the dispersion direction and multiple pixels in the band separation direction.

14. The optical system of claim 1, wherein pixels of the detector area are grouped into a plurality of macro-pixels.

15. The optical system of claim 1, wherein the optical system is configured to synchronize an acquisition window, associated with obtain one or more read-out signals, to the excitation light and one or more other elements of the optical system associated with manipulating at least one of the excitation light, the optical signal, one or more of the plurality of spectral bands, or one or more of the plurality of optical elements.

16. The optical system of claim 15, wherein the optical system is configured to synchronize the acquisition window and the one or more other elements in association with performing time-gated Raman spectroscopy, time-resolved Fluorescence spectroscopy, dynamic real-time spatial offset Raman spectroscopy (SORS), laser induced breakdown spectroscopy (LIBS), or photo-acoustic spectroscopy.

17. The optical system of claim 1, further comprising a sampling interface mounted on a hermetic package that houses the optical device or that houses the optical device, the collecting element, and the optical source.

18. The optical system of claim 1, further comprising a shifting element to dynamically adjust a spatial separation between an illumination optical path of the optical system and a detection optical path of the optical system.

19. The optical system of claim 1, further comprising a filter to remove one or more excitation wavelengths from the optical signal.

20. An optical system, comprising:
an optical source to provide an excitation light;
a collecting element to direct an optical signal, received in response to incidence of the excitation light on a sample, to an optical device;
the optical device to:
separate the optical signal into a plurality of spectral bands that are spatially or angularly separated along a band separation direction, each spectral band of the plurality of spectral bands having a different spectral range,
disperse spectral components of a spectral band, of the plurality of spectral bands, along a dispersion direction to form a dispersed spectral band,
manipulate the dispersed spectral band in association with imaging the spectral band onto a detector area of a detector array of the optical device; and
a controller to obtain one or more read-out signals from the detector array.

21. An optical system, comprising:
an optical source to provide an excitation light;
a collecting element to direct an optical signal, received in response to incidence of the excitation light on a sample, to an optical device;
the optical device comprising:
a separating element to separate the optical signal into a plurality of spectral bands; wherein spectral ranges differ among each spectral band of the plurality of spectral bands;
a dispersive element comprising a dispersive region, wherein the dispersive region is to disperse spectral components of a spectral band, of the plurality of spectral bands to form a dispersed spectral band;
an optical element is to manipulate the dispersed spectral band in association with imaging the spectral band onto a detector area of a detector array, and
the detector array comprising the detector area; and
a controller to coordinate operation of the optical source with operation of the collecting element or one or more elements of the optical device such that timing of receipt of the optical signal is synchronized with timing of an acquisition window of the detector area.
